(19) United States
(12) Patent Application Publication
(10) Pub. No.: US 2010/0147269 A1
(43) Pub. Date: Jun. 17, 2010

(54) Internal Combustion Engine With Optimal Bore-To-Stroke Ratio

(75) Inventors: Daniel L. Flowers, San Leandro, CA (US); Joel Martinez-Frias, Redwood City, CA (US); James M. Cleeves, Redwood City, CA (US)

Correspondence Address: Vierra Magen Marcus & DeNiro LLP, 575 Market Street, Suite 2500, San Francisco, CA, 94105, US

(73) Assignee: CLEEVES ENGINES INC., San Carlos, CA (US)

(21) Appl. No.: 12/624,276

(22) Filed: Nov. 23, 2009

Related U.S. Application Data
(63) Continuation-in-part of application No. 12/478,629, filed on Jun. 4, 2009.
(60) Provisional application No. 61/117,219, filed on Nov. 23, 2008.

(51) Int. Cl. F02B 75/28

(52) U.S. Cl. 123/51 R

(57) ABSTRACT

An internal combustion engine. The engine includes at least one cylinder having a bore diameter, a piston for traveling within each cylinder between a first position and a second position, wherein the distance between the first position and the second position defines a stroke length, and thermal barriers on the surfaces of the combustion chamber near top dead center. In one embodiment, the engine utilizes asymmetric effective compression and expansion strokes. To maximize efficiency of the engine, a ratio of the bore diameter to stroke length of the internal combustion engine comprises a range between 0.5 to 1.0.

### CLAIM OF PRIORITY

This application claims priority under 35 U.S.C. §119(e) to U.S. provisional application No. 61/117,219 titled “Internal Combustion Engine with Optimal Bore-to-Stroke Ratio,” which was filed with the U.S. Patent & Trademark Office on Nov. 23, 2008, and claims priority under 35 U.S.C. §120 to U.S. nonprovisional application Ser. No. 12/478,629 titled “Internal Combustion Engine,” which was filed with the U.S. Patent & Trademark Office on Jun. 4, 2009.

### BACKGROUND

Internal combustion engines are used to power vehicles and other machinery. A typical reciprocating internal combustion engine includes a body, a piston, at least one port, at least one valve, a crankshaft (which serves as a drive shaft), and a connecting rod. The body defines a cylinder. The piston is located inside the cylinder so that a surface of the piston and a wall of the cylinder define an internal volume. The port is located in the body, and allows air and fuel into and exhaust gas out of the internal volume. The valve is movable between a first position wherein the port is open, and a second position wherein the valve closes the port. The crankshaft has a bearing section rotatably mounted to the body and an offset throw section. A connecting rod is connected between the piston and the offset throw section of the crankshaft, such that reciprocating movement of the piston causes rotation of the offset throw section of the crankshaft about a crankshaft axis.

A reciprocating engine of the above kind typically has a cylinder head that defines the internal volume together with the surface of the piston and the wall of the cylinder. Heat is transferred to the cylinder head and conducts through the cylinder head, thereby resulting in energy losses from the internal volume and a reduction in efficiency. One way of increasing efficiency is by reducing an area of the surface of the piston and increasing a stroke (a diameter of a circle that the offset throw section follows) of the piston. A large stroke results in high forces created on the piston and other components of the engine, so that the engine can only be run at lower revolutions per minute with a corresponding reduction in power. Partial-power operation in a conventional combustion engine is also less efficient than full-power operation because a gas within the internal volume does not expand and cool down fully during partial-power operation, resulting in a relatively high temperature of the gas when it is exhausted. The heat in the exhaust gas is an energy loss that results in a reduction in efficiency.

### SUMMARY

One aspect of the present technology is to maximize the efficiency of an internal combustion. The efficiency is maximized by extracting work from a thermodynamically efficient cycle that minimizes the work lost to, by way of example only, mechanical friction, breathing, and cooling or exhaust processes.

One aspect of the present technology is to limit heat loss during a high temperature, high pressure portion of the cycle. By doing so, high engine output efficiency (inclusive of losses) can be improved. Limiting the amount of heat that can leave through the walls of the combustion chamber when the piston is near top dead center (TDC) (i.e. near minimum combustion chamber volume and at the part of the cycle where most of heat release occurs) compared to the losses to the cylinder wall improves the overall efficiency of the cycle.

One aspect of the present technology is to optimize the bore-to-stroke ratio and/or heat loss through the various components of the combustion chamber (e.g. thermal barrier coatings). By doing either, distribution of heat losses during the cycle can be managed, and therefore parameters can be chosen to optimize heat loss distribution for efficient engine operation.

### BRIEF DESCRIPTION OF THE DRAWINGS

FIG. 1 is a perspective view of an internal combustion engine, according to an embodiment of the technology described herein.

FIG. 2 is cross-sectional side view of a right valve arrangement, a right casting, and a central connecting piece forming part of the engine shown in FIG. 1.

FIG. 3 is a schematic side view illustrating the of power-delivery arrangements of the engine shown in FIG. 1.

FIGS. 4A-4G are cross-sectional side views illustrating full-power operation of the engine shown in FIG. 1.

FIGS. 5A-5G are cross-sectional side views illustrating partial power operation of the engine shown in FIG. 1.

FIG. 6 is a block diagram of a control system forming part of the engine.

FIG. 7 is a graph of brake and indicated efficiency as a function of bore-to-stroke ratio.

FIG. 8 is a graph of brake and indicated mean effective pressure as a function of bore-to-stroke ratio.

FIG. 9 is a graph of heat transfer rate as a function of bore-to-stroke ratio.

FIG. 10 is a graph of volumetric efficiency and fuel energy input as a function of bore-to-stroke ratio.

FIG. 11 is a graph of instantaneous surface area as a function of crank angle.

FIG. 12 is a graph of instantaneous heat transfer coefficient as a function of crank angle.

FIG. 13 is a graph of instantaneous heat transfer rate as a function of crank angle.

FIG. 14 illustrates a snapshot of instantaneous heat transfer rate as a function of crank angle as shown in FIG. 13, focusing on specific crank angle degrees.

FIG. 15 is a graph of instantaneous heat release rate as a function of crank angle.

FIG. 16 is a graph of cumulative work during cycle as a function of crank angle.

FIG. 17 is a cross-sectional side view illustrating operation of an engine having a conventional piston design, with the piston at a bottom dead center position.

FIG. 18 shows the piston in FIG. 14 at a top dead center position.

FIG. 19 is a top cross-sectional view of the piston design shown in FIGS. 17-18.

### DETAILED DESCRIPTION

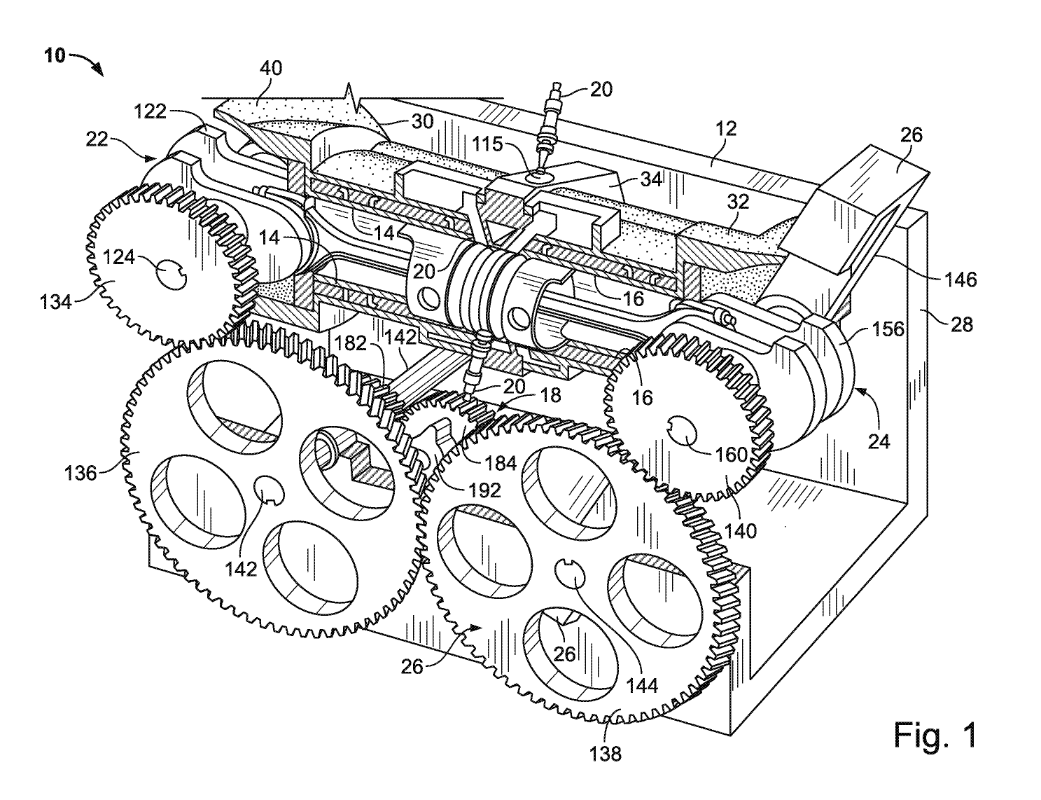

The present technology will now be described in reference to FIGS. 1-16. Internal combustion engine efficiency is maximized by extracting work from a thermodynamically efficient cycle that minimizes the work lost to either mechanical friction, breathing, and cooling or exhaust processes. Work can be more effectively extracted from high temperature, high pressure gas (i.e. high availability) than from lower temperature, lower pressure gas (lower availability). Therefore limiting heat loss during the high temperature, high pressure portion of the cycle can aid achieving high engine output efficiency (inclusive of losses). Limiting the amount of heat that can leave through the walls of the combustion chamber when the piston is near top dead center (i.e. near minimum combustion chamber volume and at the part of the cycle where most of heat release occurs) compared to the losses to the cylinder wall improves the overall efficiency of the cycle. Changing the bore-to-stroke ratio and/or changing the heat loss through the various components of the combustion chamber (e.g. thermal barrier coatings) allow for managing the distribution of heat losses during the cycle, and therefore parameters can be chosen to optimize heat loss distribution for efficient engine operation.

The technology described herein optimizes the bore-to-stroke ratio for a 4-stroke opposed piston engine and/or a conventional piston design for best engine-out efficiency. More generally, technology solves the problem of choosing engine design parameters based on the interactions between heat transfer, bore-to-stroke ratio, surface-area-to-volume ratio, burn rate, and efficiency that are applicable to piston engines in general. Conventional thinking is that higher heat transfer reduces efficiency in engines. The technology herein describes engine design conditions that promote efficiency despite higher heat transfer.

The timing of the instantaneous heat transfer in an internal combustion engine is critical to the heat transfer effect on efficiency. Under certain conditions, cycles can simultaneously have higher heat transfer and higher efficiency, relative to a similar engine with slightly different characteristics (for example, bore-to-stroke ratio).

The instantaneous heat transfers occurring during combustion and expansion is most important to the interaction with cycle efficiency. An example of this is the 4-stroke opposed piston engine. The cylinder bore, and piston stroke are key geometric design parameters, and for a given displacement, greater stroke length results in smaller piston bore. As stroke length increases, the surface area to volume ratio at top dead center (TDC), or minimum volume, will decrease. Reduced surface-area-to-volume ratio at TDC can mean less heat transfer at TDC because there is less surface area to transfer heat through. At bottom dead center (BDC), or maximum volume, the surface-area-to-volume ratio will be greater for longer stroke engines, promoting more heat transfer during this part of the cycle. A 4-stroke opposed piston engine is exemplary only, and is not intended to limit the scope of the technology described herein. It is within the scope of the technology described herein to apply to a 2-stroke opposed piston engine, a conventional internal combustion engine, and the like.

The overall result is that longer strokes promote less heat transfer at TDC and more heat transfer at BDC. In some cases the overall heat transfer can increase with longer strokes. The most important effect on thermodynamic cycle efficiency is heat transfer during compression, combustion and expansion, so lower surface-to-volume-ratio at TDC reduces heat transfer during combustion. The energy generated by combustion is thermodynamically of higher quality (high pressure and high temperature), thus reducing removal of high quality energy by heat transfer can improve the overall cycle efficiency. Sometimes cycle efficiency will be higher because of this effect, despite increased overall heat transfer.

For a given engine displacement, there will be an optimal bore-to-stroke ratio for an engine that will balance thermodynamic cycle efficiency with instantaneous heat transfer and yield optimal engine performance. This effect of bore-to-stroke ratio on engine operation is illustrated in the accompanying figures. This example is a 250 cc opposed piston 4-stroke operating at 4000 RPM with an over expanded cycle (18:1 compression ratio, late intake valve closing to achieve approximately 10:1 effective compression ratio determined by knocking limits, same valve timing for all cases). The connecting rod length is 1.75 times the stroke. A single side-mounted spark plug is used.

FIG. 1 of the accompanying drawings illustrates components of an internal combustion engine 10, according to an embodiment of the invention, including a body 12, left and right valve arrangements 14 and 16, components of a valve-control system 18, spark plugs 20, left and right power delivery arrangements 22 and 24, respectively, and a combustion chamber size-varying mechanism 26.

The body 12 includes a base portion 28, left and right castings 30 and 32, and a central connecting piece 34. The left and right castings 30 and 32 are mounted to the central connecting piece 34. The assembly, including the left and right castings 30 and 32 and the central connecting piece 34, is then secured to the base portion 28 to form a unitary piece with the base portion 28, the castings 30 and 32 and the central connecting piece 34 being immovably connected to one another.

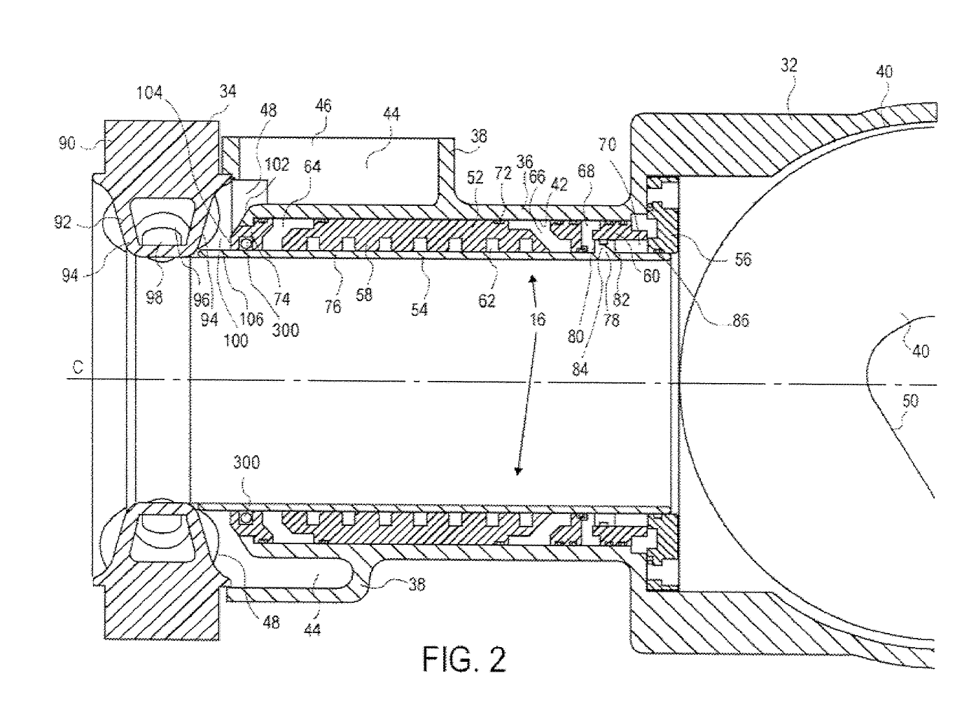

As shown in FIG. 2, the right casting 32 includes a cylinder block portion 36, an air intake and distribution portion 38, and a crankshaft housing 40. The cylinder block portion 36 has a circular bore 42 machined from right to left therein. The air intake and distribution portion 38 forms a volute 44 around a left section of the cylinder block portion 36. The volute 44 has an inlet 46 at the top. Left ends of the cylinder block portion 36 and the air intake and distribution portion 38 form a circumferential outlet 48 out of a left side of the volute 44.

The crankshaft housing 40 is an extension from the cylinder block portion 36, and is larger in size than the cylinder block portion 36. One of two drive shaft openings 50 is shown in the cross-section of FIG. 2. The right valve arrangement 16 includes an oil path-defining piece 52, a sleeve valve 54, and a retaining piece 56.

The oil path-defining piece 52 is inserted from right to left into the circular bore 42. The oil path-defining piece 52 is formed into a valve-cooling portion 58 on the left, and a valve-actuation portion 60 on the right. The valve-cooling portion 58 has a helical groove 62 formed in an inner surface thereof, and inlet and outlet grooves 64 and 66, respectively, formed in an outer surface thereof. The inlet and outlet grooves 64 and 66 are in communication with opposing ends of the helical groove 62. The valve-actuation portion 60 has oil pressure slots 68 and 70 formed therein. The oil path-defining piece 52 is inserted into the circular bore 42 until a seat 74 on the oil path-defining piece 52 contacts a seat on the cylinder block portion 36, and is prevented from further movement into the circular bore 42. An enclosed cavity is then defined by the inlet groove 64 and a surface of the circular bore 42. Similarly, cavities are defined by the outlet groove 66 and a surface of the circular bore 42 and by the oil pressure slots 68 and 70 and surfaces of the circular bore 42.

The sleeve valve 54 is inserted from right to left into the oil path-defining piece 52. The sleeve valve 54 has a sleeve portion 76 and a ridge component 78 around and close to a right end of the sleeve portion 76. An enclosed helical oil-cooling passage is defined by an outer surface of the sleeve portion 76, and by surfaces of the helical groove 62. Left and right surfaces 80 and 82, respectively, on the ridge component 78 complete the cavities formed by the oil pressure slots 68 and 70. The sleeve valve 54 is slidably movable to the right and back to the left relative to the oil path-defining piece 52. An O-ring 84 is located between the ridge component 78 and the valve-actuation portion 60 to allow for sliding movement of the ridge component 78 relative to the valve-actuation portion 60.

The retaining piece 56 is in the form of a ring having an outer diameter substantially larger than the oil path-defining piece 52, and an inner diameter that is only slightly larger than an outer diameter of the sleeve portion 76. The retaining piece 56 is located over a right end of the sleeve portion 76, so that a right end of the oil path-defining piece 52 abuts against a left surface of the retaining piece 56. The retaining piece 56 is then secured to the right casting 32 to retain the oil path-defining piece 52 in position. Bolts may be used to releasably secure the retaining piece 56 to the right casting 32, to allow for removal and maintenance of the oil path-defining piece and the sleeve valve 54. An O-ring 86 is located between an inner diameter of the retaining piece 56 and an outer surface of the right end of the sleeve portion 76, to allow for sliding movement of the sleeve portion 76 past the retaining piece 56. The O-ring 86 seals the cavity that is formed in part by the right surface 82, one of the oil pressure slots 70, and an outer surface of the sleeve portion 76, so that oil cannot leak therefrom, while still allowing for sliding movement of the sleeve portion 76 relative to the retaining piece 56.

The central connecting piece 34 is in the form of a ring having an outer portion 90 and an inner portion 92. The inner portion 92 has opposing side surfaces 94 that taper toward one another. A fuel supply cavity 96 forms a volute within the inner portion 92 and around a horizontal central axis C of the central connecting piece 34. The central connecting piece 34 further includes spark plug sleeves 98, through which spark plugs can be inserted through the fuel supply cavity 96 without coming into contact with any fuel in the fuel supply cavity 96.

When the right casting 32 is mounted to the central connecting piece 34, an air inlet port 100 is defined between one of the side surfaces 94 on one side, and by end surfaces 102 and 104 of the cylinder block portion 36 and the oil path-defining piece 52 on the other side. The air inlet port 100 is a ring-shaped port around a horizontal central axis C of the sleeve valve 54. The air inlet port 100 extends from the outlet 48 of the air intake and distribution portion 38, and has a mouth 106 at a left end of the sleeve portion 76. Movement of the sleeve valve 54 to the right opens the mouth 106, and movement to the left closes the mouth 106.

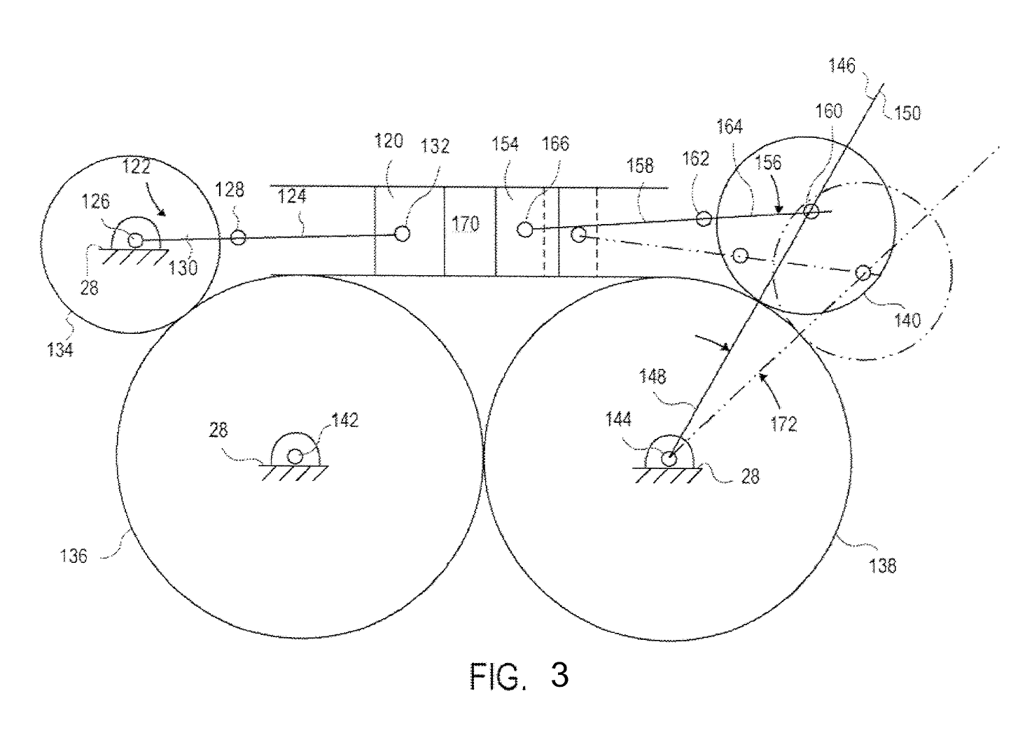

Reference is now made to FIGS. 1 and 3 in combination. In order not to obscure the drawings, not every detail in FIG. 1 is shown in FIG. 3, and not every detail in FIG. 3 is shown in FIG. 1. In general, FIG. 1 shows only general large assemblies, and FIG. 3 shows the components better that make up the larger assemblies.

The left power delivery arrangement 22 includes a left piston 120, a left crankshaft 122, and a left connecting rod 124. The left crankshaft 122 has opposing bearing sections 126 (the bearing sections 126 are located behind one another into the paper), an offset throw section 128, and connecting sections 130 that connect the offset throw section 128 to the bearing sections 126. The bearing sections 126 are rotatably mounted on journal bearings (not shown) in the crankshaft housing 40 of the left casting 30. The entire left crankshaft 122 revolves about a left crankshaft axis through the bearing sections 126 that rotate on the journal bearings.

The left piston 120 resides within the left casting 30, and is slidably movable to the left and to the right on an inner surface of the sleeve valve 54 of the left valve arrangement 14. A left connecting pin 132 is secured to the left piston 120. The left connecting rod 124 has opposing ends that are pivotably connected to the offset throw section 128 of the left crankshaft 122, and to the left connecting pin 132. Rotation of the left crankshaft 122 causes reciprocating movement of the piston 120 by a distance that equals two times a distance from the bearing sections 126 to the offset throw section 128 of the left crankshaft 122.

Another embodiment may or may not have all the components of the left power delivery arrangement. A cam-based connection may, for example, be provided. In a cam-based arrangement no connecting rod is provided and a cam serves the purpose of moving a piston.

The combustion chamber size-varying mechanism 26 includes a train of first, second, third, and fourth gears 134, 136, 138, and 140 respectively, first and second gear shafts 142 and 144, respectively, and a combustion chamber size-varying carriage 146. The first gear 134 is mounted to one bearing section 126 of the left crankshaft 122. Splines on the first gear 134 and the bearing section 126 of the left crankshaft 122 ensure that the first gear 134 does not slip on the bearing section 126 of the left crankshaft 122, and that the first gear 134 thus rotates together with the left crankshaft 122. The first and second gear shafts 142 and 144 are rotatably mounted through respective bearings to the base portion 28. The spatial relationship between the bearing sections 126 of the left crankshaft 122 and the first and second gear shafts 142 and 144 is fixed, because they are all mounted to the same base portion 28. The second and third gears 136 and 138 are mounted to and rotate with the first and second gear shafts 142 and 144, respectively. The second gear 136 meshes with the first gear 134, and the third gear 138 meshes with the second gear 136. An effective working diameter of the first gear 134 is exactly two times an effective working diameter of the second gear 136, and the third gear 138 has the same effective working diameter as the second gear 136. The second gear 136 also has exactly twice as many teeth as the first gear 134, and the third gear 138 has the same number of teeth as the second gear 136. The second and third gears 136 and 138 thus rotate at exactly half tire rotational speed of the first gear 134.

The combustion chamber size-varying carriage 146 has first and second opposed ends 148 and 150, respectively. The first end 148 is pivotably secured to the second gear shaft 144, so that the second end 150 can move on a radius with a center point at the center line of the second gear shaft 144.

The right power delivery arrangement 24 includes a right piston 154, a right crankshaft 156, and a right connecting rod 158. The right piston 154 is located within and slides up and down the sleeve valve 54 in FIG. 2. The right crankshaft 156 has opposing bearing sections 160, an offset throw section 162, and connecting sections 164 that connect the offset throw section 162 to the bearing sections 160. A right connecting pin 166 is secured to the right piston 154. The right connecting rod 158 has opposed ends that are pivotably secured to the right connecting pin 166 and the offset throw section 162 of the right crankshaft 156. The bearing sections 160 of the right crankshaft 156 are rotatably secured on respective journal bearings (not shown) to the combustion chamber size-varying carriage 146. The entire right crankshaft 156 can rotate on a right crankshaft axis through the bearing sections 160. Rotation of the right crankshaft 156 causes reciprocating movement of the right piston 154. A distance that the right piston 156 travels is equal to or close to twice a distance from the crankshaft axis through the right bearing sections 160 to an axis of the offset throw section 162.

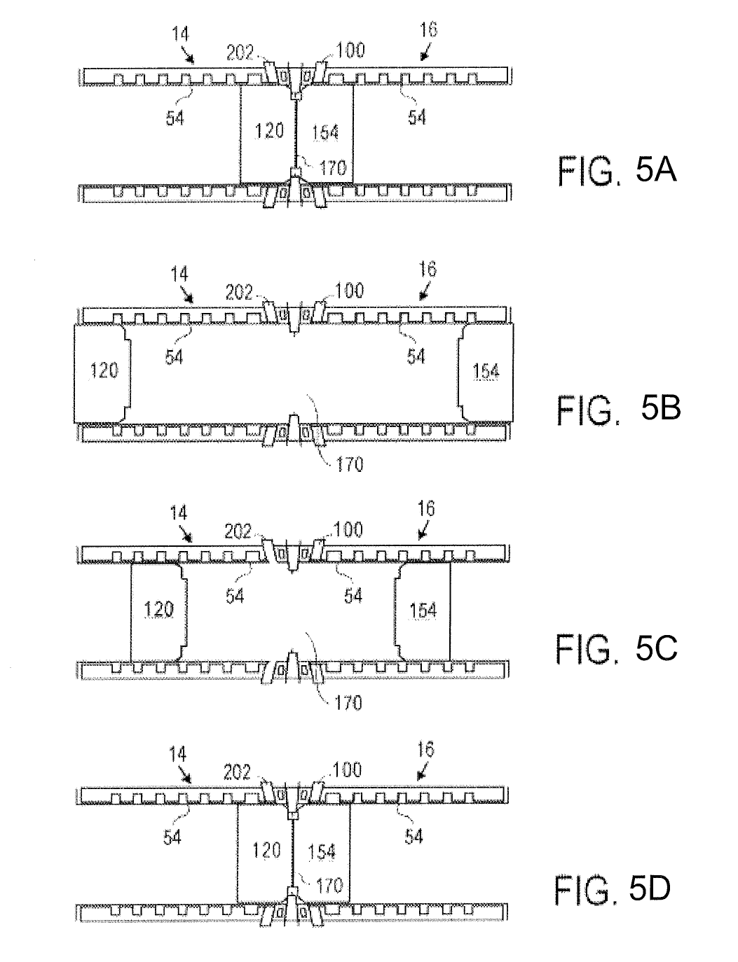

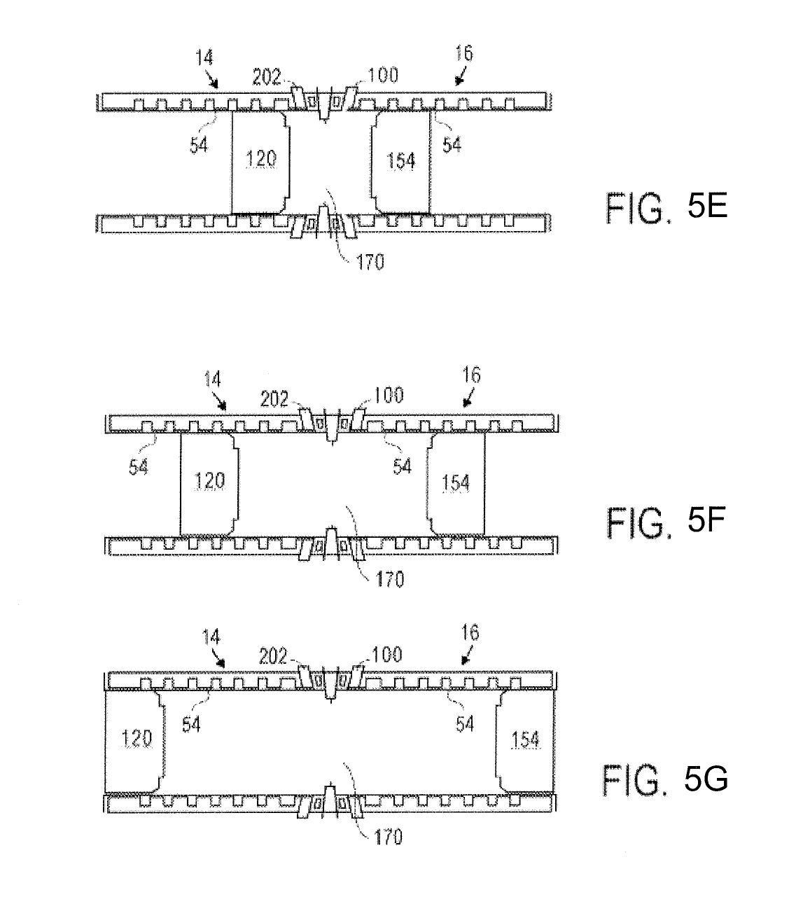

An internal volume 170 is defined between facing surfaces of the left and right pistons 120 and 154, and by inner surfaces of the central connecting piece 34 and the left and right valve arrangements 14 and 16. FIGS. 1 and 5 show the left and right crankshafts 120 and 156 rotated to respective angles so that the left and right pistons 120 and 154 are at their farthest positions from the bearing sections 126 and 160, respectively, and the internal volume 170 is at its smallest. Pivoting of the combustion chamber size-varying carriage 146 through an angle 172 rotates the bearing section 160 of the right crankshaft 156 through the angle 172 about the second gear shaft 144. Rotation of the bearing section 160 of the right crankshaft 156 to the right causes movement of the right piston 154 to the right. Movement of the right piston 154 to the right enlarges the internal volume 170. It should be noted that it is the combustion chamber, i.e., the minimum size of the internal volume 170 that is enlarged, i.e., when the right crankshaft 156 is in an angular position wherein the right piston 154 is the farthest from the bearing section 160 of the right crankshaft 156. An enlargement of the minimum size of the internal volume 170 also causes a corresponding increase in a maximum size of the internal volume 170.

The fourth gear 140 is mounted to the bearing section 160 of the right crankshaft 156 so as to rotate together with the right crankshaft 156. The fourth gear 140 meshes with the third gear 138. The fourth gear 140 has exactly half the number of teeth of the third gear 138, and has an effective diameter that is exactly half the effective diameter of the third gear 138. The first and fourth gears thus rotate at the same angular velocity, but in opposite directions. The pistons 120 and 154 move away and toward one another. Movement of the pistons 120 and 154 is approximately in phase, and the only difference in phase between the pistons 120 and 154 is small and due to pivoting of the combustion chamber size-varying carriage 146 through the angle 172.

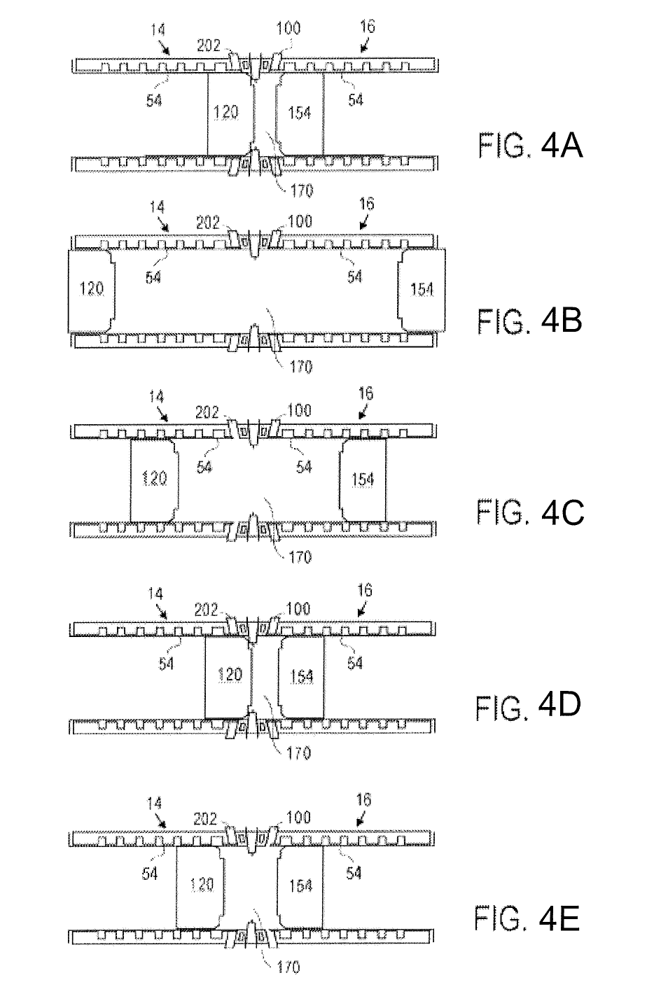

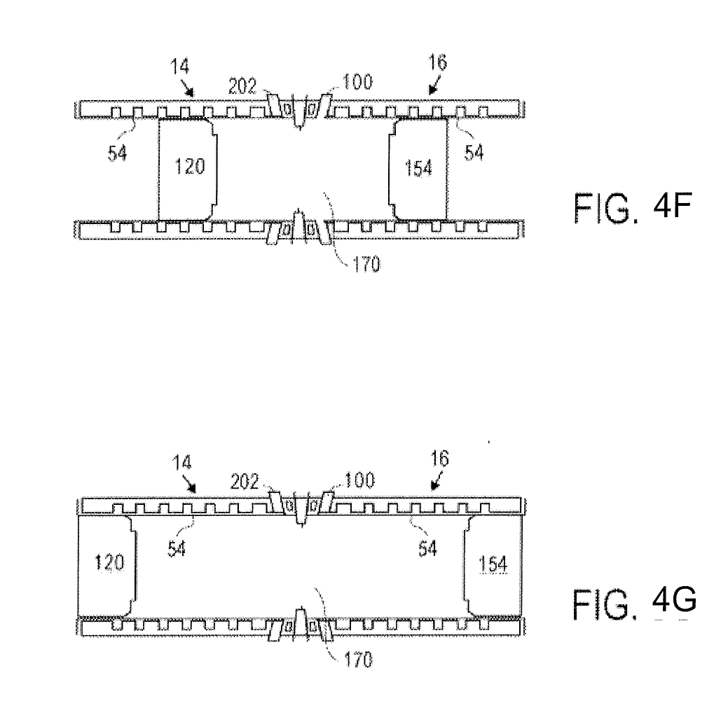

FIG. 4A now illustrates the position of the left and right pistons 120 and 154 at ignition and when the size of the internal volume 170 is at its smallest for full-power operation. The sleeve valve 54 is maintained toward the left, wherein the sleeve portions 76 close the air inlet port 100. With further reference to FIG. 4A, a sleeve valve 54 of the left valve arrangement 14 closes an exhaust port 202. The internal volume 170 is filled with pressurized air and fuel, typically vaporized petroleum. Referring to FIG. 1, a current is provided to the electrodes 118 of the spark plugs 20, which ignites the fuel. Ignition causes combustion, and an increase in pressure within the internal volume 170. The increased pressure moves the left piston 120 to the left, and the right piston 154 to the right.

FIG. 4B illustrates the left and right pistons 120 and 154 after the end of expansion of the internal volume 170 due to the increased pressure of combustion. The expansion causes a reduction in pressure and temperature within the internal volume 170. With reference to FIG. 3, expansion of the internal volume 170 causes rotation of the left crankshaft 122 in a clockwise direction, and rotation of the right crankshaft 156 in a counterclockwise direction. A force that is generated through the connecting rod 122 creates a clockwise torque on the bearing sections 126. An extension of one of the bearing sections 126 can form an output shaft through which the torque can be delivered to a drive train. A force created by the right connecting rod 158 creates a counterclockwise torque on the right bearing section 160. The torque created on the right bearing section 160 is provided to the fourth gear 140. The counterclockwise torque on the fourth gear 140 is provided through the third and second gears 138 and 136 sequentially as a clockwise torque on the first gear 134. The clockwise torque created on the first gear 134 is provided to the first bearing section 126 and added to the torque due to the left connecting rod 124.

FIG. 4C illustrates the left and right pistons 120 and 154 midway through exhaust. The sleeve valve 54 of the left valve arrangement 14 has been moved to the left to open the exhaust port 202. The internal volume 170 reduces in size, and combusted gas discharges through the exhaust port 202.

FIG. 4D shows the left and right pistons 120 and 154 at the end of exhaust. The internal volume 170 is again at its smallest size for full power operation. The sleeve valve 54 of the left valve arrangement 14 is moved to the right to close the exhaust port 202.

FIG. 4E illustrates the position of the left and right pistons 120 and 154 and the position of the sleeve valves 54 early in the intake stroke. The left piston 120 has moved to the left by a small distance, and the right piston 154 has moved to the right by a small distance. To compensate for a possible increase in pressure on the left surface 80 compared to a pressure on the right surface 82, the sleeve valve 54 has moved to the right by a small distance. The air inlet port 100 is now open by a small amount. Fuel is provided through a fuel opening (not shown) into the fuel supply cavity 96 and the end surface 112 is moved to the right to open the fuel outlet port 108. The fuel is allowed to flow from the fuel supply cavity 96 through the fuel outlet port 108. Referring again to FIG. 4E, air and fuel enter into the internal volume 170. As shown in FIG. 4F, the left and right pistons 120 and 154 continue to move to the left and right, respectively. Referring again to FIG. 4F, the air inlet port 100 is now open to its maximum. The position illustrated in FIG. 48F corresponds to a peak 204 in FIG. 4.

FIG. 4G illustrates the left and right pistons 120 and 154 at the end of intake. The pistons 120 and 154 have moved their maximum distances or strokes to the left and right, respectively. Referring again to FIG. 4G, the sleeve valve 54 of the right valve arrangement 16 closes the air inlet port 100.

The expansion stroke of FIG. 4B imparts angular momentum to flywheels connected to the left and right crankshafts 120 and 156 shown in FIG. 2. The momentum of the flywheels moves the left and right pistons 120 and 154 through the sequence illustrated in FIGS. 4C through 4G. The momentum then moves the left and right pistons 120 and 154 from their positions to the position illustrated in FIG. 4A, thereby reducing the size of the internal volume 170 and compressing the air within the internal volume 170.

Partial-power operation is now illustrated, primarily with reference to FIGS. 5A-5G, and with the aid of the other figures heretofore described. With reference to FIG. 2, partial power operation is when the combustion chamber size-varying carriage 146 is rotated through the angle 172 counterclockwise to the left. During partial-power operation, the valve-control carriage 180 is rotated through the angle 200 clockwise so that the components are in the position illustrated by the phantom lines.

When comparing FIGS. 5A and 4A, it can be seen that the internal volume 170 during ignition is much smaller for partial power than for full power. When comparing FIGS. 5B and 4B, it will show that a maximum size of the internal volume is also smaller during partial-power operation than during full-power operation. FIGS. 5C and 5D show the positions of the left and right pistons 120 and 154 during exhaust and at the end of exhaust, respectively. The internal volume in FIG. 5D is smaller than the internal volume in FIG. 4D.

FIG. 5E illustrates the position of the left and right pistons 120 and 154 early during the intake stroke. The sleeve valve 54 of the right sleeve arrangement 16 has opened by a small amount. Referring to FIG. 4, the distance that the sleeve valve 54 of the right sleeve arrangement 16 is displaced is reflected by comparing the height of the peak 204 to the height of the peak 206. It should also be noted that, although FIGS. 5E and 4E appear to be similar, there is in fact an advancement of the phase from the peak 204 to the peak 206, so that maximum opening of the air inlet port 100 only occurs in FIG. 4F during full-power operation, whereas maximum opening of the air inlet port 100 occurs in FIG. 5E during partial-power operation.

FIG. 5F illustrates the positioning of the left and right pistons 120 and 154 midway through intake. Referring again to FIG. 5F, the sleeve valve 54 of the right sleeve arrangement 16 closes the air inlet port 100, and the fuel outlet port 108 is also closed. Referring to FIG. 5G, the left and right pistons 120 and 154 continue to move to the left and to the right respectively, while the sleeve valves 54 are closed. Enlargement of the internal volume 170 causes a slight decrease in pressure. When the left and right pistons 120 and 154 begin to return toward one another, the pressure within the internal volume 170 again returns to the pressure of the internal volume 170 in FIG. 5F. The left and right pistons 120 and 154 then return to their position shown in FIG. 5A for purposes of ignition.

Referring to FIG. 2, heat that is generated in the combustion process is illustrated with reference to FIGS. 4A-4G and 5A-5G may cause overheating of the sleeve valve 54. An oil inlet port (not shown) through the cylinder block portion 36 is connected to the inlet groove 64 and a similar oil outlet port is connected to the outlet groove 66. A cooling fluid in the form of cooling oil is pumped through the oil inlet port and out of the oil outlet port. The cooling oil flows through the helical groove 62 over an outer surface of the sleeve portion 76. Heat convects from the sleeve portion 76 to the cooling oil, and is removed by the oil through the oil outlet port. Oil flow is from left to right, which ensures that the oil is as cool as possible closer to the left of the sleeve valve 54, although oil flow can be reversed to reduce pressure at the inlet groove 64 if it is found that oil leaks excessively past the left of the sleeve valve 54. Fuel circulating through the fuel supply cavity 96 cools the seat 74 that the end surface 112 comes into contact with.

One advantage of the invention is that energy losses are minimized in all modes. With reference to FIGS. 1-3, it can be seen that the internal volume 170 is entirely defined by inner surfaces of the sleeve portions 76 of the left and right valve arrangements 14 and 16, an inner surface of the inner portion 92, and facing surfaces of the left and right pistons 120 and 154. A volume of the internal volume 170 is thus approximately the area of the left piston 120 multiplied by a distance between the facing surfaces of the left piston 120 and the right piston 154. It is also within the scope of the invention that the internal volume 170 be slightly larger than the surface area of the face of the left piston 120 multiplied by the distance between the facing surfaces of the left and right pistons 120 and 154, for example 20% larger, more preferably 10% larger when the left and right pistons 120 and 154 are at their maximum stroke. Because of the facing relationship of the left and right pistons 120 and 154, there is no cylinder head for the left piston 120 through which heat can escape, nor is there a cylinder head for the right piston 154 through which heat can escape. The facing relationship between the left and right pistons 120 and 154 thus assists in containment of heat energy, with a corresponding increase in efficiency.

What should also be noted is that the left and right pistons 120 and 154 have relatively small diameters compared to the volume of the internal volume 170. The relatively low surface area to volume ratio further assists in reducing heat losses. A reduction in surface area of a piston normally corresponds with an increase in the stroke of the piston in order to obtain the same displacement, but because left and right power delivery arrangements 22 and 24 are provided, the stroke of each piston 120 or 154 is approximately half of what would be required if only a single piston is provided. Because of the relatively short stroke length of, for example, the left piston 120, it can run at higher revolutions per minute and produce more power than in an arrangement where only a single piston is provided.

The extra heat that is contained with the facing relationship between the left and right pistons 120 and 154 can be extracted more efficiently in the partial-power operation of FIGS. 5A-5G. In all low heat loss engines such as this, energy that is transferred through a piston to a drive train and energy losses in an exhaust of gas in an exhaust cycle together are more than 65%, more preferably more than 70% and more preferably more than 75% of the energy of the fuel.

What should be noted specifically with reference to FIGS. 5E-5G is that the gas within the internal volume 170 expands to its maximum. As mentioned previously, expansion of the gas within the internal volume 170 causes cooling of the gas. Maximum expansion thus results in maximum cooling of the gas in the internal volume 170 and maximum extraction of heat from the gas. When the gas is exhausted, it is relatively cool compared to an arrangement having no variable compression and running at partial power. What should also be noted is that expansion and compression is asymmetric similar to the Atkinson Cycle or the Miller Cycle. A synergistic effect is created by the combination of low heat loss and asymmetric expansion.

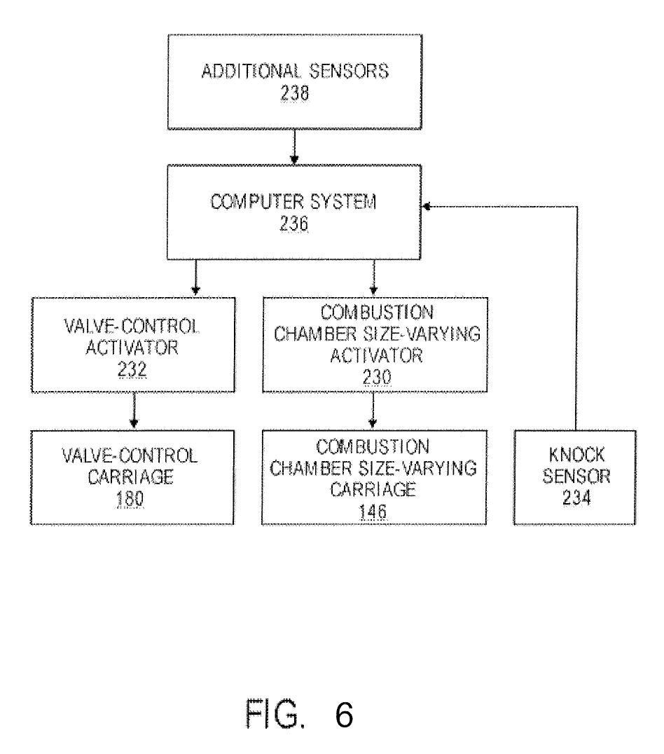

FIG. 6 illustrates

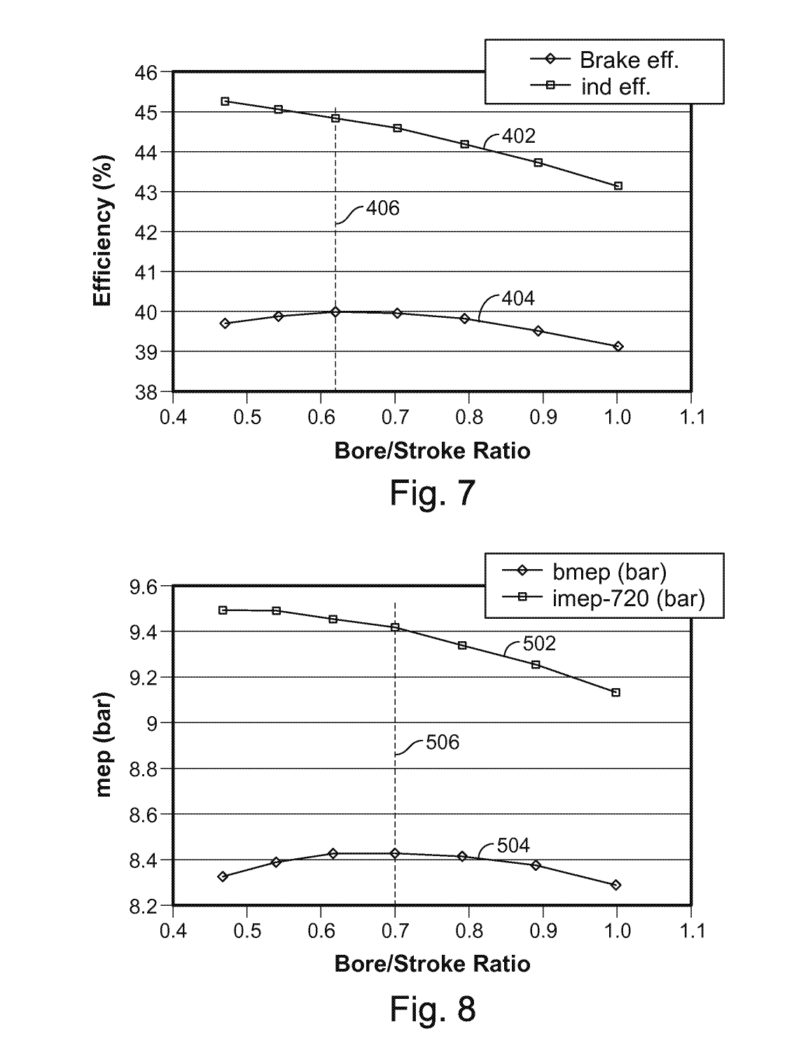

FIGS. 7-19 illustrates various engine design parameters as a function of bore-to-stroke ratio or crank angle degree (CAD). The data plotted in the graphs shown in FIGS. 7-19 was generated by operating a 250 cc 4-stroke opposed piston at 2200 RPM, and stoichiometric fuel-air ratio (lambda=1). The characteristics shown in FIGS. 7-19 are not limited to a particular displacement volume, a 4-stroke engine or a specific RPM. In fact, the data shown in FIGS. 7-19 and discussed herein are not limited to any single engine configuration. For example, the findings in FIGS. 7-19 apply to an internal combustion engine employing opposed pistons with a single cylinder having asymmetric effective compression and expansion strokes (as shown in FIG. 1) as well as a conventional internal combustion engine designs.

FIG. 7 shows indicated thermal efficiency (indicated efficiency, line 402) and brake thermal efficiency (brake efficiency, line 404) as a function of bore-to-stroke ratio (for each piston, both pistons have the same bore and stroke). Indicated efficiency is thermodynamic efficiency including heat transfer but without friction, and brake includes friction. As shown in FIG. 7, indicated efficiency (line 402) increases as the bore-to-stroke ratio decreases. For example, the indicated efficiency was measured at approximately 43% in correlation with a 1.0 bore-to-stroke ratio. When the bore-to-stroke ratio is reduced to 0.5, the indicated efficiency increased two percent to approximately 45%. However, the brake efficiency (line 404) peaks at the tradeoff point between increased efficiency with reduced bore-to-stroke ratios and increased friction due to longer strokes. As shown in FIG. 7, the brake efficient peaks at approximately 40% when the bore-to-stroke ratio is approximately 0.62 (as shown by reference line 406).

FIG. 8 shows indicated mean effective pressure (imep, line 502) and brake mean effective pressure (bmep, line 504) as a function of bore-to-stroke ratio. FIG. 8 shows that the imep and bmep share similar tradeoffs as shown in FIG. 7. That is, at a certain bore-to-stroke ratio, the bmep is reduced as the bore-to-stroke ratio continues to decrease. For example, FIG. 8 shows that maximum bmep (approximately 8.4 bar) is achieved when the bore-to-stroke ratio is about 0.7 (shown by reference line 506). Further reducing the bore-to-stroke ratio to, for example 0.5, actually decreases the bmep to about 8.3 bar, which is the same bmep as if the bore-to-stroke ratio was 1.0.

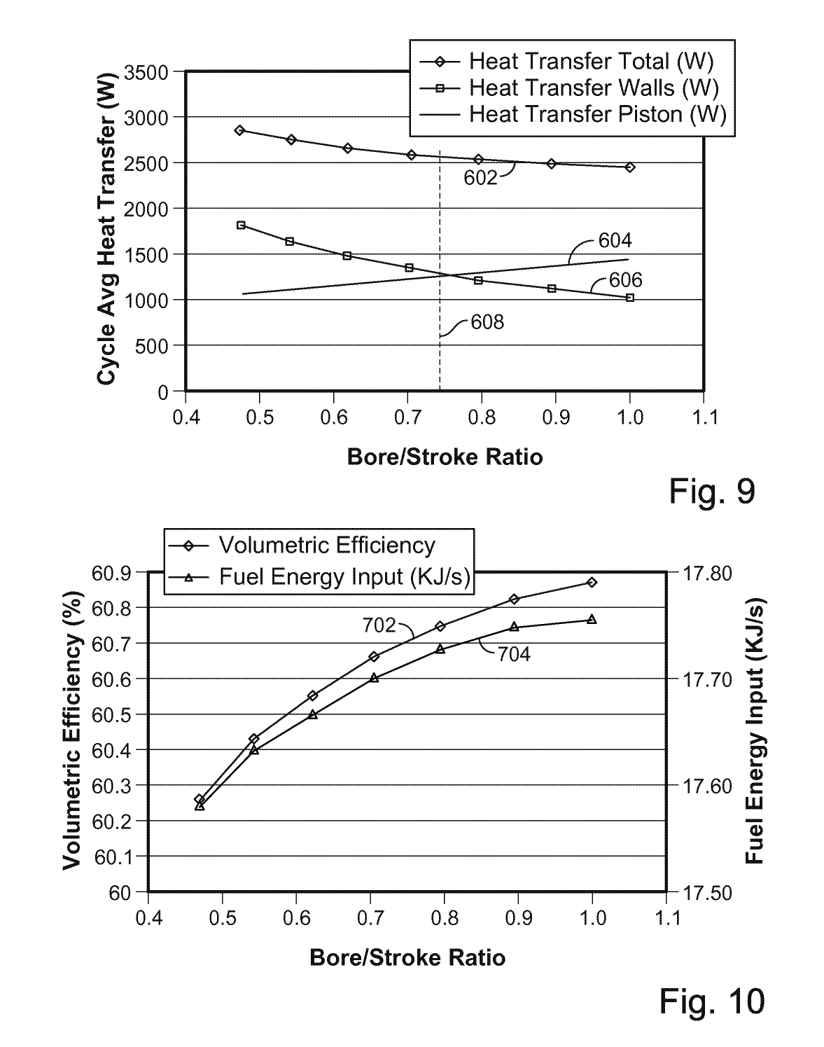

FIG. 9 shows the total aggregate heat transfer for the cycle (line 602) and aggregate heat transfer to the walls (line 606) and pistons (line 604) as a function of bore-to-stroke ratio (for 250 cc 4-stroke opposed piston at 2200 RPM). FIG. 9 shows that heat transfer to the pistons (line 604) decreases with smaller bore-to-stroke ratio due to the reduction in bore diameter. However, as expected, heat transfer to the walls (line 606) increases as the bore-to-stroke ratio decreases because of the longer stroke and thus an increase in cylinder wall surface area (as compared to higher bore-to-stroke ratios). The aggregate heat transfer (line 602) increases as bore-to-stroke ratio decreases; however the thermodynamic efficiency improvement is enough to offset the cycle aggregate increase in heat transfer, limited by friction. Reference line 608 shows that heat transfer to the pistons (line (604) and heat transfer to the walls (line 606) are substantially equal at a bore-to-stroke ratio of 0.7.

FIG. 10 shows volumetric efficiency (line 702) and fuel flow (line 704) both as a function of bore-to-stroke ratio. As shown in FIG. 10, both volumetric efficiency and fuel flow decrease with smaller bore-to-stroke ratios. However, power density actually can increase (imep, bmep shown in FIG. 5) up to the friction tradeoff. FIG. 10 shows volumetric efficiency as the left Y-axis and Fuel Energy Input as the right Y-axis as a function of bore-to-stroke ratio.

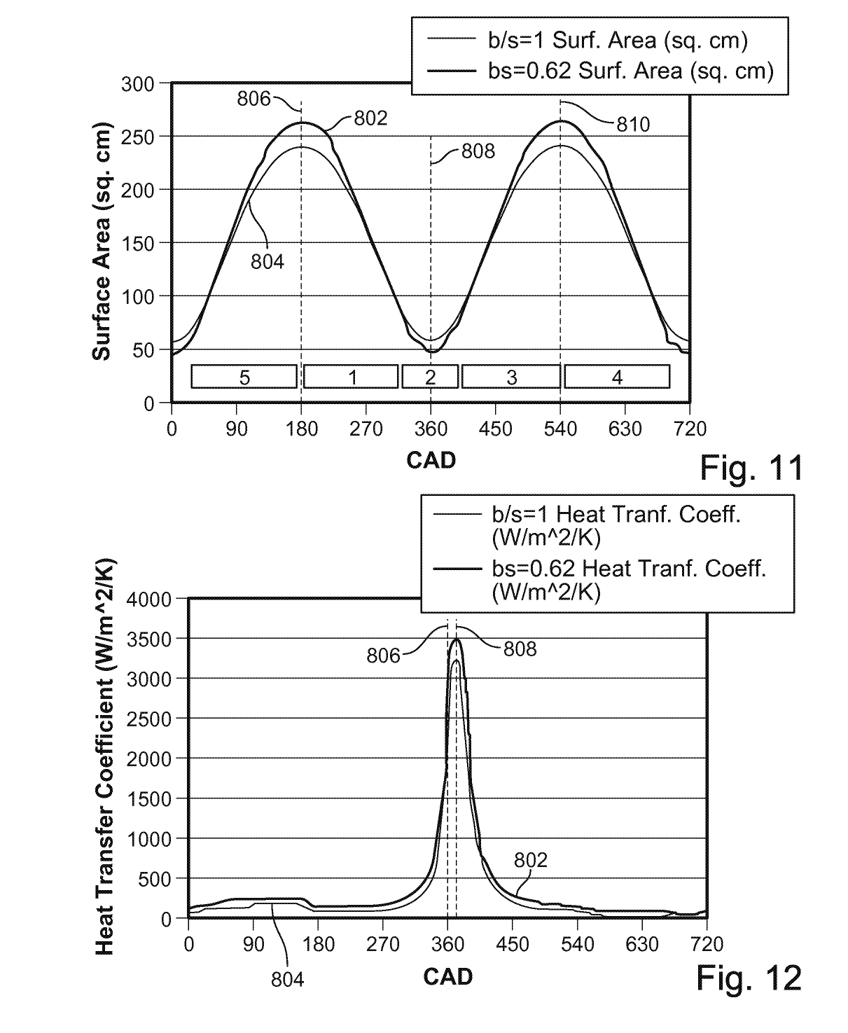

FIGS. 11-19 illustrate the comparison of instantaneous quantities during the 4-stroke cycle between two different bore-to-stroke ratios, 1.0 and 0.62. A bore-to-stroke ratio of 1.0 represents equal bore diameter and stroke distance. The bore-to-stroke ratio of 0.62 represents the bore-to-stroke ratio that achieved the highest brake efficiency (FIG. 7).

FIG. 11 shows the comparison of instantaneous surface area in the combustion chamber as a function of CAD. FIG. 11 illustrates the change in surface area during each stage of a cycle. Stage 1 represents a compression stage. Stage 2 represents a combustion stage. Stage 3 represents an expansion stage. Stage 4 represents an exhaust stage. Stage 5 represents an intake stage. Line 802 in FIG. 11 represents a bore-to-stroke ratio of 0.62 (per piston). Line 804 represents a bore-to-stroke ratio of 1.0 (per piston). FIG. 11 shows that a bore-to-stroke ratio of 0.62 (line 802) has less surface area at combustion TDC (360 CAD) than if the bore-to-stroke ratio was 1.0. Less surface area at combustion TDC attributes to a lower heat transfer rate during the combustion stage of the cycle. A bore-to-stroke ratio of 0.62 also creates a larger surface area at BDC (180, 540 CAD) than if the bore-to-stroke ratio was 1.0. A larger surface area around BDC equates to a higher heat transfer rate later in the expansion stroke.

FIG. 12 shows the instantaneous convective heat transfer coefficient as a function of CAD for both a bore-to-stroke ratio of 0.62 (line 802) and 1.0 (line 804). As shown in FIG. 12, the instantaneous convective heat transfer coefficient peaks higher for line 802, which is the bore-to-stroke ratio of 0.62. However, FIG. 11 also shows, by reference line 808, that the higher instantaneous convective heat transfer coefficient for line 802 is not achieved until after TDC (360 CAD, line 806) has passed. FIG. 12 shows instantaneous heat transfer coefficient as a function of CAD for a 250 cc 4-stroke opposed piston at 2200 RPM for bore-to-stroke ratios per piston of 1:1 and 0.62.

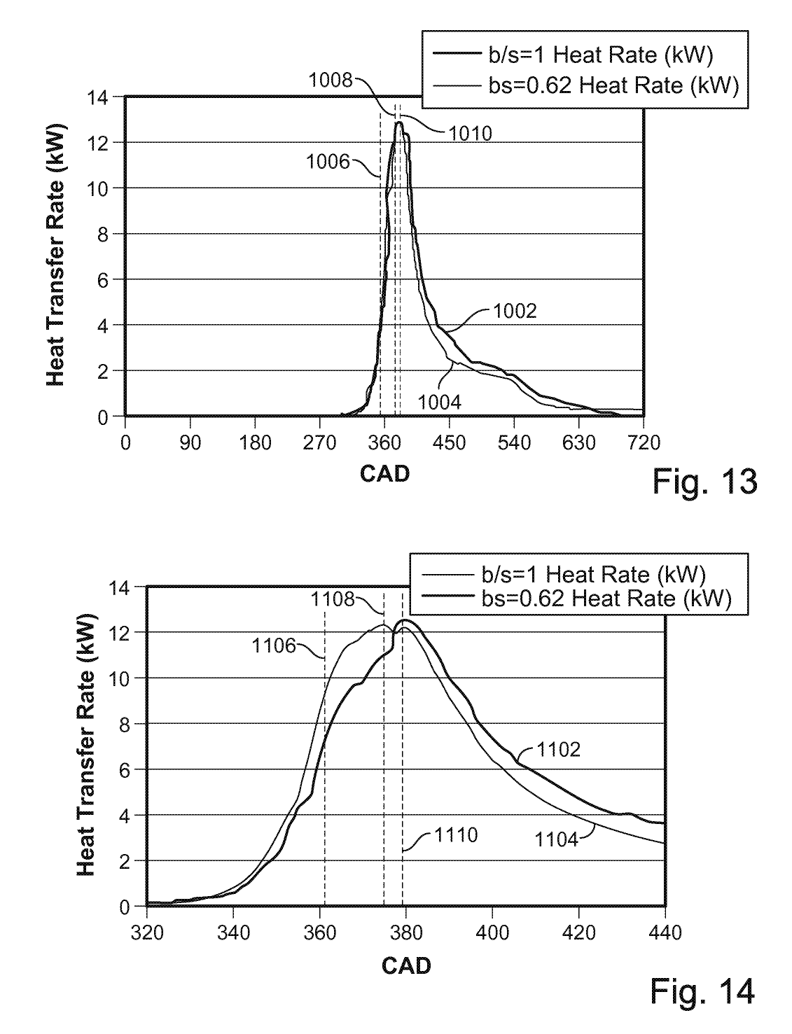

FIGS. 13-14 shows that rise in heat transfer rate as a function of CAD. Line 1002 represents operation of an engine having a bore-to-stroke ratio of 0.62. Line 1004 represents operation of an engine having a bore-to-stroke ratio of 1.0. FIG. 13 shows that line 1002, which represents the smaller bore-to-stroke ratio of 0.62, achieves the maximum heat transfer rate after TDC (360 CAD) as shown by reference line 1010. This maximum heat transfer rate also occurs later in the cycle than the maximum heat transfer rate is achieved by a bore-to-stroke ratio of 1.0 (line 1004), which is achieved at reference line 1008. FIG. 13 shows instantaneous heat transfer rate as a function of CAD for a 250 cc 4-stroke opposed at 2200 RPM.

FIG. 14 illustrates a specific range of CAD, focusing largely on the combustion stage of the cycle shown in FIG. 13. Line 1102 in FIG. 14 represents an engine having a bore-to-stroke ratio of 0.62. Line 1104 in FIG. 14 represents an engine having a bore-to-stroke ratio of 1.0. FIG. 14 illustrates that, the heat transfer rate is actually higher for much of the cycle shown in FIG. 13 for an engine with a shorter bore-to-stroke ratio (line 1102). In particular, FIG. 14 shows that to the right of reference line 1110, representing CAD after 380, the heat transfer rate of line 1102 remains higher than the heat transfer rate of line 1104. However, the timing of the heat transfer with the 0.62 bore/stoke ratio removes less high quality heat (high temperature, high pressure) from the compression stroke than is removed for a larger bore-to-stroke ratio, such as line 1104. In particular, FIG. 14 shows that the maximum heat transfer rate achieved by the bore-to-stroke ratio 1.0 (line 1104) is achieved at reference line 1108, which again, is prior to reference line 1108. FIG. 14 also shows that the heat transfer rate is higher at TDC (reference line 1106) for line 1104 (bore-to-stroke ratio 1.0) than line 1102 (bore-to-stroke ratio 0.62).

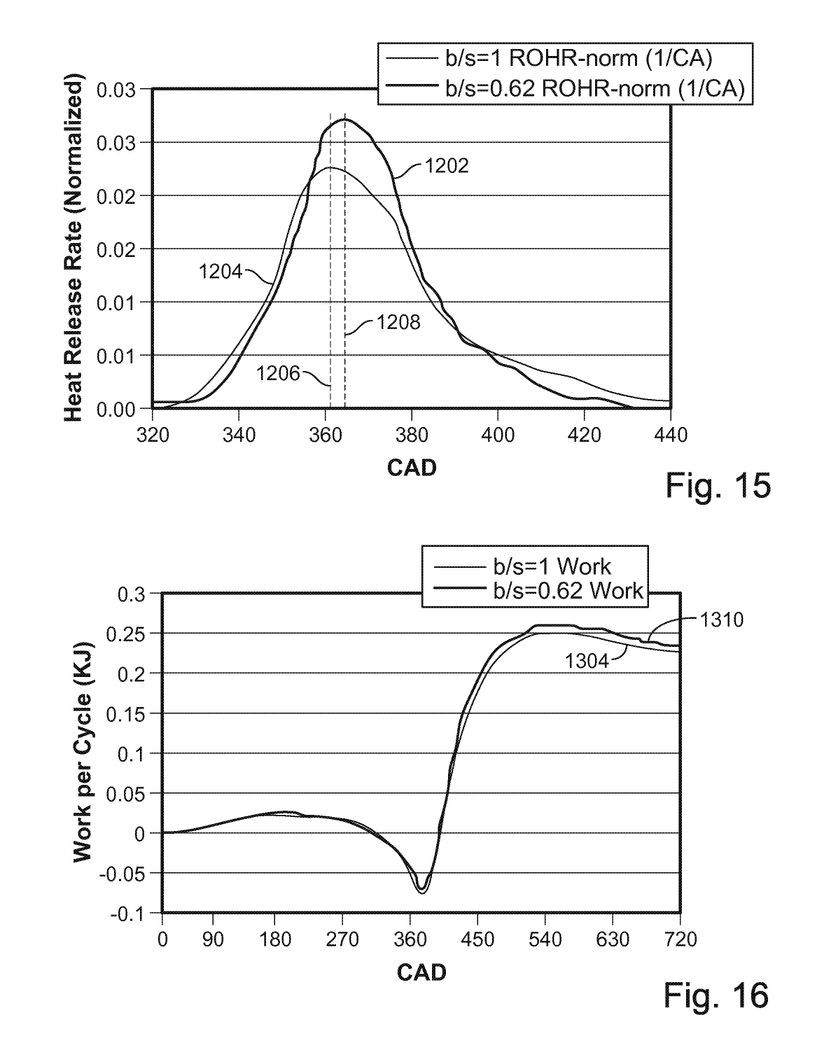

FIG. 15 shows the burn duration for a bore-to-stroke ratio per piston of 0.62 (line 1202) and bore-to-stroke ratio 1.0 (line 1204). FIG. 15 shows instantaneous heat release rate as a function of CAD for a 250 cc 4-stroke opposed piston at 2200 RPM. FIG. 15 shows that the smaller bore-to-stroke ratio (line 1202) has a faster burn than line 1204 due to higher turbulence levels and shorter distances for the flame to travel within a cylinder associated with the smaller bore-to-stroke ratio.

FIG. 16 shows the integrated work for the cycle as a function of CAD. Line 1310 in FIG. 16 represents a bore-to-stroke ratio of 0.62. Line 1304 represents a bore-to-stroke ratio of 1.0. The earlier timed heat transfer losses in the larger bore-to-stroke ratio case are amplified; resulting in lower work output and efficiency for the longer bore-to-stroke ratio.

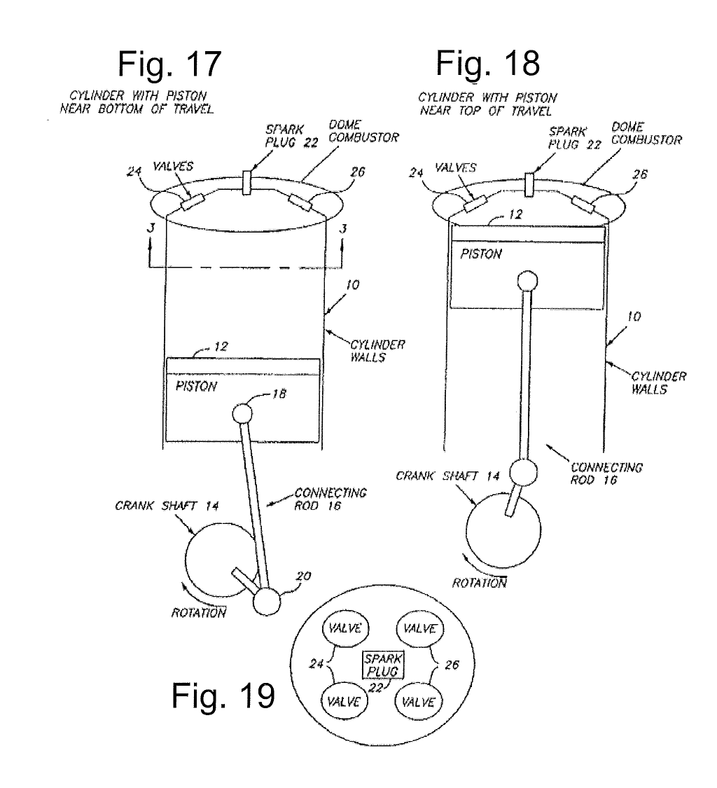

FIGS. 17-19 illustrate a conventional piston design. As shown in FIGS. 17-19, the main components of an IC engine are a cylinder 10, a cylinder head 11, a reciprocating piston 12, a crankshaft 14, and a connecting rod 16. The cylinder 10 had a bore diameter D2. The stroke length of the piston 12 is S2. Thus, an optimal bore-to-stroke ratio, as discussed above, is also applicable to the conventional piston design shown in FIGS. 17-18. A wrist pin 18 connects one end of the connecting rod to the piston, and a crank pin 20 connects the other end of the connecting rod to the crankshaft. The piston moves up and down in the cylinder to define a combustion chamber 21 (dome combustor) in the space between the piston and the cylinder head. The motion of the piston up and down in the cylinder is transmitted through the connecting rod to rotate the crankshaft, which is connected to a device (not shown) to extract power.

Most IC engines operate in a 4 stroke system for each cycle of the engine. That is, the piston travels up and down the cylinder twice, and the crank shaft makes two complete rotations for one cycle of the engine. The cycle is further divided into 5 phases. Starting with the cylinder full of fuel and air and the piston at the bottom, the cycle follows:

1) Compression: The piston travels from the bottom to the top of the cylinder, compressing the gases (a mixture of fuel and air) inside.

2) Combustion: A spark plug 22 in the cylinder ignites the high pressure air and fuel releasing the chemical energy in the mixture raising the pressure and the temperature. If the engine is a diesel, no spark plug is required, because during the compression phase the air and fuel mixture are heated enough to cause ignition of the mixture. This occurs while the air and fuel are in the dome-shaped space at the top of the cylinder, often called the dome combustor, or combustion chamber.

3) Expansion: The high pressures and temperatures of combustion drive the piston down, expanding the gases. The expansion is often called the power stroke because that is when power is extracted from the engine.

4) Exhaust: An exhaust valve 24 connected to the exhaust system (not shown) opens, allowing the burned mixture to exit. The piston travels from the bottom to the top, driving the exhaust from the cylinder.

5) Intake: The valve connected to the exhaust closes, and an intake valve 26 connected to the intake (not shown) opens, allowing a fresh mixture of air and fuel to enter. For engines which use in-cylinder fuel injectors, only air flows through the intake valve. The piston travels from top to bottom, drawing in a fresh supply of air and fuel, and the cycle is ready to begin again.

Of course, in addition to optimizing the bore-to-stroke ratio, a number of other factors may contribute to improving the efficiency of an internal combustion engine. By way of example only, thermal barrier coatings can be used in conjunction with the bore-to-stroke ratio analysis described above. In addition, there are a number of other factors that interact with these two concepts (bore-to-stroke ratio and thermal barrier coatings) to affect engine performance:

1) Friction goes up as the stroke length is increased (bore-to-stroke ratio decreases for constant volume);

2) Turbulence and therefore convective heat transfer goes up as the stroke is increased;

3) Larger engines are limited to lower speeds due to inertia (mean piston speed);

4) Flame speed needs to be fast to limit the time the surfaces are exposed to hot gas;

5) Flame speeds go up with turbulence, tending to improve burn rate;

6) Turbulence can also be enhanced with design features other than stroke length; and

7) Large bore diameter generally means that the flame travel distance is long.

Limiting heat loss results in a higher temperature at the end of the compression stroke and leads to more autoignition (end-gas knock) sensitivity. Knock can be controlled somewhat by controlling flame speed or reducing compression ratio.

Pre-ignition is also initiated by the mixture contacting high temperature components of the combustion chamber. High heat capacity insulators stay hot through the engine cycle to add heat to the unburned charge and enhance pre-ignition tendencies.

Retaining heat in the high temperature gas will help symmetric compression ratio/expansion ratio engines as well as asymmetric engines. Asymmetric engines will net higher overall efficiency but the optimum amount of asymmetry will be dependent on the amount and timing of heat loss as well as friction etc.

Valve timing and overlap impact both the maximum mass flow of the engine as well as the residual gas mass at the start of the intake stroke.

Trapped gas energy is added to the intake air raising its temperature and decreasing it's density. Low heat transfer engine cycles can results in high residual gas temperatures that may inhibit breathing, reducing volumetric efficiency. This higher temperature leads to end-gas knock sensitivity and lower mass flow.

One relationship between the parameters discussed above may include equation (1) below:

Efficiency=f(x)[A+B*expansion ratio+C*bore-to-stroke ratio+D*displacement+E*(heat flux through piston and cylinder head/heat flux through cylinder wall)+F*(heat capacity of cylinder head surface)+G*heat capacity of piston surface+H*inlet valve open timing+I*inlet valve duration+J*exhaust valve overlap+K*compression ratio+L*added turbulence+M*start of ignition+N*octane rating of fuel]. Letters A-N used above in equation (1) are each an empirical coefficient.

We can use this relationship to establish the optimum conditions for a given piston/cylinder head/cylinder wall material and temperature condition, at a given displacement to determine the best bore stroke combinations to yield high efficiency. Plots can be generated to allow graphical selection of the optimum bore-to-stroke for a range of engine sizes and a range of materials characteristics.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An internal combustion engine, comprising:
a cylinder having a bore diameter;
a piston for traveling within the cylinder between a first position and a second position, wherein the distance between the first position and the second position defines a stroke length;
thermal barriers on the surfaces of the combustion chamber near top dead center;
asymmetric effective compression and expansion strokes; and
wherein a ratio of the bore diameter to stroke length of the internal combustion engine comprises a range between 0.5 to 1.0.

2. An internal combustion engine, comprising:
a body defining first and second cylinders in communication with each other, the first and second cylinders having a first and second bore diameter;
first and second pistons in the first and second cylinders respectively, front surfaces of the first and second pistons and walls of the first and second cylinders defining an internal volume;
the first piston for traveling within the first cylinder between a first position and a second position, wherein the distance between the first position and the second position defines a first stroke length;
the second piston for traveling within the second cylinder between a third position and a fourth position, wherein the distance between the third position and the fourth position defines a second stroke length; and
wherein a ratio of the first bore diameter to the first stroke length and the second bore diameter to the second stroke length of the internal combustion engine comprises a range between 0.5 to 1.0.
